(19) United States
(12) Patent Application Publication
(10) Pub. No.: US 2010/0317422 A1
(43) Pub. Date: Dec. 16, 2010

(54) Gaming machine

(75) Inventors: Scott Delekta, Las Vegas, NV (US); Julian White, North Bondi (AU)

Correspondence Address: MASUVALLEY & PARTNERS, 8765 AERO DRIVE, SUITE 312, SAN DIEGO, CA, 92123, US

(73) Assignee: Konami Gaming, Inc., Las Vegas, NV (US)

(21) Appl. No.: 12/456,209

(22) Filed: Jun. 12, 2009

(51) Int. Cl. A63F 9/24; A63F 13/00

(52) U.S. Cl. 463/16; 463/30; 463/25

(57) ABSTRACT

The present invention is a gaming machine including a controller, which a) executes a primary game on a display, b) executes a secondary game in which a plurality of areas are defined on the display such that an award is allocated to at least one of the plurality of areas and when an area to which the award has been allocated is selected, a process according to the award is executed by the controller, and c) stores a result of the secondary game inclusive of information regarding the selected area so that the stored result of the secondary game is used in a next secondary game.

### TECHNICAL FIELD

The present invention relates to a gaming machine having a primary game and a secondary game for use in a casino, a pachisuro machine parlor, etc.

### BACKGROUND OF THE INVENTION

Slot machines are popular gaming machines in casinos. There are many types of slot machines and some of the slot machines have a display for displaying a plurality of cells or columns in which symbols (or indicia) are shown randomly in each game. When the symbols shown in the cells or columns form one or more winning combinations, a corresponding prize is paid out to the player. Also, recent slot machines typically have a primary game and a secondary game. The secondary game may include any type of game, either similar to or completely different from the primary game. The secondary game is initiated upon the occurrence of a selected event or outcome of the primary game. For example, the secondary game may be embodied as a progressive game in which a progressive award may be paid out. Often times, the progressive game is designed to be able to pay out prizes much higher than the prizes usually obtained in the primary game so that it can enhance the player's excitement.

An example of such a gaming machine employing the progressive game can be seen in U.S. Patent Application Publication No. 2007/0259713. The gaming machine or wagering game terminal disclosed in Publication No. 2007/0259713 is designed to provide an incentive for the player to return to the game at a later time after the player left the game. Specifically, the invention of 2007/0259713 is directed to a method and system for operating a wagering game terminal where unused game assets accrued by players in one game are restored to them in a subsequent game. The gaming system involves awarding game assets to the players as they progress through a game. The players may be represented by characters or avatars in each game, and the accrued game assets are then added to the inventory of the avatars. The game assets may or may not be usable in the current game or even in the current gaming session. In the latter case, the game assets are returned to player characters or avatars in a subsequent game or a gaming session. This allows the players to retain the benefits of their game assets when they decide not to use them or are unable to use them in the current game or gaming session.

Thus, gaming machine manufacturers are striving to introduce new features to the gaming machines in order to attract more players to the gaming machines and entice longer play. The gaming machine of the present invention is directed to providing such a new feature to the gaming machines having primary and secondary games, particularly to the gaming machines employing a progressive game as a secondary game.

### SUMMARY OF THE INVENTION

One aspect of the present invention is a gaming machine including: a display; and a controller, which a) executes a primary game, b) executes a secondary game in which a plurality of areas are defined on the display such that an award is allocated to at least one of the plurality of areas and when an area to which the award has been allocated is selected, a process according to the award is executed by the controller, and c) stores a result of the secondary game inclusive of information regarding the selected area so that the stored result of the secondary game is used in a next secondary game.

According to the above mentioned gaming machine of an embodiment of the present invention, the result of the secondary game inclusive of information regarding the selected area is used in the next secondary game. Therefore, the player can feel like to play the game longer when the result of the secondary game may appear to lead to a higher chance of winning an award in the next secondary game. Thus, the gaming machine can entice longer play of the game.

The controller may store an amount of progressive award that is progressively increased according to a bet received from a player, and the award allocated to the at least one of the plurality of areas may include the progressive award. Thus, the present invention can be favorably applicable to the gaming machine having a progressive game as a secondary game.

In one preferred embodiment, a visual indication for indicating the at least one of the plurality of areas to which the award is allocated is shown on the display, and the selection of an area is carried out by the controller based on a random number. Such a visual indication may include a mark displayed in the at least one of the plurality of areas to which the award is allocated. In an alternative embodiment, information regarding the allocation of the award to at least one of the plurality of areas is not shown on the display and the gaming machine further comprises an interface for allowing the player to select one of the plurality of areas whereby upon the selection of one of the plurality of areas by the player, the controller controls the display to visually show whether the selected area is allocated with the award or not. Such an interface may include a touch panel provided over the display, for example. In both embodiments, the player cannot predict the game result following the area selection and this can enhance the expectation of the player for the award and thus make the game more fun and entertaining.

The controller may control the display to show a selector for visually indicating the result of selection of one of the plurality of areas. This can allow the player to readily know the result of the area selection.

In one preferred embodiment, the selector may include an object shown on the display, and in the secondary game the controller selects one of the plurality of areas by using a random number and causes the object to move to the selected area. The object may be a character, such as a cat, puppy, or any other animal character, for example.

It is possible that each of the plurality of areas adjoins two or more other areas, wherein the object is caused to move from a certain area to one of its adjoining areas or stay in the same area in a single move. In such an embodiment, the object cannot “jump” to an area allocated with an award when such an award-allocated area is not adjoining the area in which the object is currently positioned, and the chance that the object will move to the award-allocated area in a few games apparently depends on the distance between the object and the award-allocated area. Therefore, when the object comes in proximity of the award-allocated area, the player will have a high expectation that the object is likely to move to the award-allocated area in a few games and thus may be encouraged to continue to play the game.

Preferably, each of the plurality of areas may have a probability function associated with it, where the probability function defines a probability that the object will move from the area to each of the plurality of areas when the object resides in the area, and the controller may select one of the plurality of areas by using the random number and the probability function associated to an area in which the object currently resides. It should be noted that the probability function defines not only the probability that the object moves to other areas but also the probability that the object stays in the current area. With such a probability function associated to each area, it is possible to easily adjust the behavior of the object by changing the probability function.

Another aspect of the present invention is a gaming system including a progressive controller, which a) receives a bet and increases an amount of progressive award on a basis of the bet and b) stores the amount of progressive award increased and a gaming machine including a display and a controller, which a) executes a primary game, b) executes a secondary game in which a plurality of areas are defined on the display such that an award including the progressive award is allocated to at least one of the plurality of areas and when an area to which the award has been allocated is selected, a process according to the award is executed by the controller, and c) stores a result of the secondary game inclusive of information regarding the selected area so that the stored result of the secondary game is used in a next secondary game.

According to the above described gaming system of an embodiment of the present invention, the result of the secondary game inclusive of information regarding the selected area is used in the next secondary game. Therefore, the player can feel like to play the game longer when the result of the secondary game may appear to lead to a higher chance of winning an award in the next secondary game. Thus, the gaming system can entice longer play of the game.

The progressive award may comprise a plurality of progressive award levels, and each progressive award level is allocated to one or more of the plurality of areas. Thus, the present invention can be applicable to the gaming system having a plurality of progressive award levels.

In the case where the progressive award comprises a plurality of progressive award levels and each progressive award level is allocated to one or more of the plurality of areas, it is preferred that the controller controls the display to show information regarding the number of non-selected areas to which each progressive award level is allocated. For example, when there are two progressive award levels “MAXI” and “MINI”, the display may show the number of non-selected areas to which the “MAXI” progressive award is allocated and the number of non-selected areas to which the “MINI” progressive award is allocated. Such information can be useful when the player determines whether or not to start or continue the game.

The controller may indicate the stored result of the secondary game on the display while the controller executes the primary game.

The gaming system may further include another display, wherein the controller indicates the stored result of the secondary game on another display while the controller executes the primary game.

Another aspect of the present invention is a method of executing a game program in a gaming machine having a display, including the steps of: executing a primary game; executing a secondary game in which a plurality of areas are defined on the display such that an award is allocated to at least one of the plurality of areas and when an area to which the award has been allocated is selected, a process according to the award is executed; and storing a result of the secondary game inclusive of information regarding the selected area so that the stored result of the secondary game is used in a next secondary game.

According to the above method of executing a game program according to an embodiment of the present invention, the result of the secondary game inclusive of information regarding the selected area is used in the next secondary game. Therefore, the player can feel like to play the game longer when the result of the secondary game may appear to lead to a higher chance of winning an award in the next secondary game. Thus, the method of executing a game program can entice longer play of the game.

### BRIEF DESCRIPTION OF THE DRAWINGS

The other and further objects, advantages and features of the present invention will be understood more fully from the following description of embodiments of the present invention with reference to the attached drawings, in which:

FIG. 1 is a perspective view illustrating an example of a gaming machine of the present invention;

FIG. 2 is a block diagram illustrating an example of a gaming machine of the present invention;

FIG. 3 is a block diagram illustrating an example of a gaming system of the present invention;

FIG. 4 is a diagram illustrating a state of an exemplary game executed by the gaming machine pertaining to the present invention;

FIG. 5 is a diagram illustrating a state of an exemplary game executed by the gaming machine pertaining to the present invention;

FIG. 6 is a diagram illustrating a state to which the game state shown in FIG. 5 has progressed further;

FIG. 7 is a diagram illustrating a state to which the game state shown in FIG. 6 has progressed further;

FIG. 8 is a diagram illustrating a state to which the game state shown in FIG. 7 has progressed further;

FIG. 9 is a diagram illustrating a state to which the game state shown in FIG. 8 has progressed further;

FIG. 10 is a diagram illustrating a state to which the game state shown in FIG. 9 has progressed further;

FIG. 11 is a diagram illustrating a state to which the game state shown in FIG. 10 has progressed further;

FIG. 12 is a diagram illustrating another example of a three-dimensional game executed by the gaming machine pertaining to the present invention;

FIG. 13 is a diagram illustrating another example of a game executed by the gaming machine pertaining to the present invention;

FIG. 14 is a diagram illustrating a state to which the game state shown in FIG. 13 has progressed further;

FIG. 15 is a diagram illustrating a state to which the game state shown in FIG. 14 has progressed further;

FIG. 16 is a diagram illustrating a state to which the game state shown in FIG. 15 has progressed further;

FIG. 17 is a diagram illustrating a state to which the game state shown in FIG. 16 has progressed further;

FIG. 18 is a diagram illustrating a state to which the game state shown in FIG. 17 has progressed further;

FIG. 19 is a flowchart illustrating an example of an operation of the gaming machine pertaining to the present invention to perform a game; and

FIG. 20 is a flowchart illustrating another example of an operation of the gaming machine pertaining to the present invention to perform a game.

### DETAILED DESCRIPTION OF INVENTION

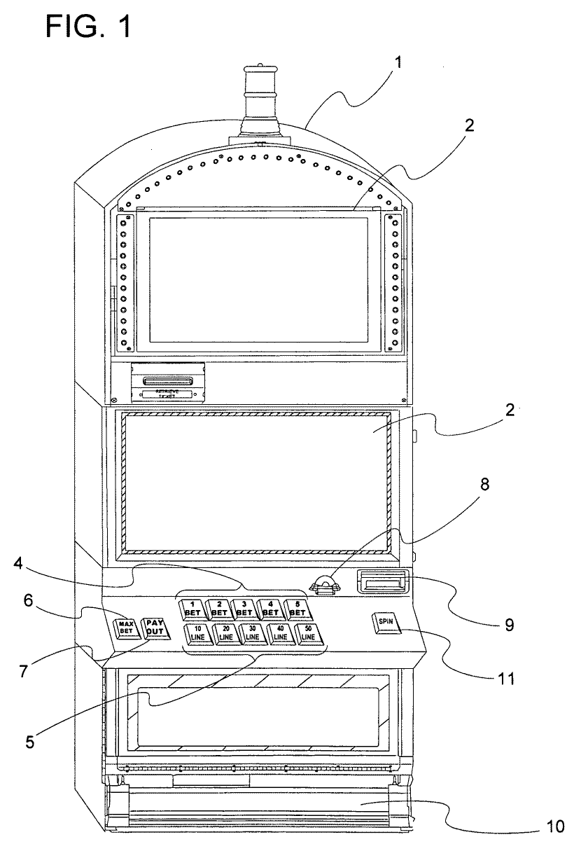

FIG. 1 is a perspective view showing an example of a gaming machine of the present invention. The gaming machine 1 illustrated in FIG. 1 is designed as a video slot machine. As shown in FIG. 1, the gaming machine 1 is provided with two displays 2. Immediately under the displays 2, there are provided BET switches 4, line-selecting switches 5, a MAXBET switch 6, a PAYOUT switch 7, a coin slot 8, a bill acceptor 9 and a spin button 11. The BET switches 4 are provided for selecting a wager per pay line. In this embodiment, the gaming machine 1 includes five BET switches from 1BET to 5BET. The line-selecting switches 5 are provided to determine how many pay lines should be selected in each slot game. In this embodiment, the gaming machine 1 includes five line-selecting switches from 10LINE to 50LINE. The spin button 11 may be used to start a slot game executed in the gaming machine 1. A coin payout mouth 10 is also provided in the lower part of gaming machine 1. The above-mentioned components equipped in the gaming machine 1 may be used to execute a primary game and a secondary game on the display 2.

The “primary game” used in this specification means a game initiated on a gaming machine at first after the gaming machine receives a bet from a player and also a game most frequently executed in an entire game executed by the gaming machine. In general, the primary game may be any game such as a slot game, a poker game or a roulette game, though in the illustrated gaming machine 1, the primary game consists of a slot game.

The “secondary game” used in this specification means a game secondly executed in an entire game executed in the gaming machine when a predetermined condition is satisfied. Whether the predetermined condition is satisfied or not may depend on a result of the primary game or may not depend on the result of the primary game. The secondary game is generally executed in order to provide a bonus to the player and therefore, it may be called “a bonus game”. An award of the secondary game is generally higher than that of the primary game in average. Also, a probability of winning in the secondary game is generally higher than that in the primary game in average. The secondary game may be configured by the same kind of game as the primary game. For example, slot games may be executed both as the primary game and as the secondary game. Alternatively, the secondary game may be configured by a different kind of game from the primary game. For example, the secondary game may be a bingo game while the primary game may be a slot game. Typically, the secondary game is a free game, i.e., executed without receiving a bet from a player.

Referring back to FIG. 1, information required by the player to play a game is displayed on the displays 2. For example, such information may include symbols used in the slot game, selected wager per pay line, activated pay lines, etc. It should be noted that in general, the information provided by the displays 2 can change depending on the game that the gaming machine 1 provides. For example, if the gaming machine 1 is adapted to provide a card game, the information may include images of cards used by the card game, and if the gaming machine 1 is adapted to provide a roulette game, the information may include an image of the roulette used in the roulette game.

The information may also include an indication to prompt a player to make certain choices in a progressive game if the gaming machine 1 is adapted to provide a progressive game. The “progressive game” is a game having a progressive award which is gradually updated according to a player's bet. In general, the progressive game has some kinds of progressive awards, and one of the progressive awards is selected to be paid out to a player if the player wins the game. In such a case, the displays 2 may also display the amount of each kind of progressive awards that a player can have a chance to obtain. Moreover, credit information that the player has input into the gaming machine 1 may be displayed on display 2. A play history of the player may be displayed on display 2 as well.

The progressive game can be divided into a linked progressive game and a stand-alone progressive game. The linked progressive game means a progressive game configured by a plurality of network-linked gaming machines. The progressive award of the linked progressive game is updated according to bets that the plurality of network-linked gaming machines receive. On the other hand, the stand-alone progressive game means a progressive game configured by a single gaming machine alone. The linked progressive game can be divided into a local area progressive game and a wide area progressive game. The local area progressive game means a progressive game executed by a plurality of gaming machines linked with each other in a certain casino. On the other hand, the wide area progressive game means a progressive game executed by a plurality of linked gaming machines located in a plurality of casinos.

As mentioned above, the BET switches 4 are switches for inputting a wager in each game. As is well known, if one credit (or unit of bet) is 5 cents, for example, the player can select 5 cents/line by pushing 1BET switch, and 10 cents/line by pressing 2BET switch, and so on. The line-selecting switches 5 are switches that can be used for determining how many pay lines should be selected in each slot game, as mentioned above. However, the switches 5 may also be used to select a card, which the player wants to discard, in the case where the gaming machine 1 provides a card game (in the porker game, for example, 10LINE switch may be used to indicate the left-end card to be discarded, 20LINE switch may be used to indicate the card on the right of the left-end card, and so on.). The number of BET switches 4 and line-selecting switches 5 may not be limited to five, but may be any suitable number. The gaming machine 1 may additionally have a switch for casting a bet as an extra bet. The “extra bet” used in this specification means a bet paid by the player in addition to the bet paid for playing the primary game.

The MAXBET switch 6 is a switch for inputting the maximum bet that a player can spend at a time in a single game. The PAYOUT switch 7 is a switch to be operated by the player when the player wants to quit the game and collect the amount of money which has been credited onto the gaming machine 1. The coin slot 8 is a hole for receiving coins as credit for playing the games. The bill acceptor 9 is a hole used to accept a bill or a cash card as credit for playing the games, or to payout the amount of money, which has been credited in the gaming machine 1, to the player. The coin payout mouth 10 is a tray to pay out a player the amount of money which has been credited in the gaming machine 1.

The gaming machine 1 related to the present invention is not limited to the above, but it may have other various functions, and/or some of the above-mentioned functions may be omitted. For example, the gaming machine 1 may have a lighting apparatus for providing illumination in a color or a plurality of colors when the player proceeds into the secondary game, for example. The gaming machine 1 may also have an apparatus for outputting music or any other sound and/or an apparatus for vibrating the whole gaming machine, when the player proceeds into the secondary game, for example. The gaming machine 1 may have three or more displays or only a single display. The gaming machine 1 may have a REPEAT switch for choosing the bet per line and number of activated pay lines that the player selected in the last game again.

Reels, roulette, etc., which are used in the game, may not necessarily be displayed on the display 2. A stepper (mechanical reels), mechanical roulette, etc. may be mounted in the gaming machine 1 instead of or in addition to images of the reels, roulette, etc. There may be a display etc. which is used in a plurality of gaming machines in common.

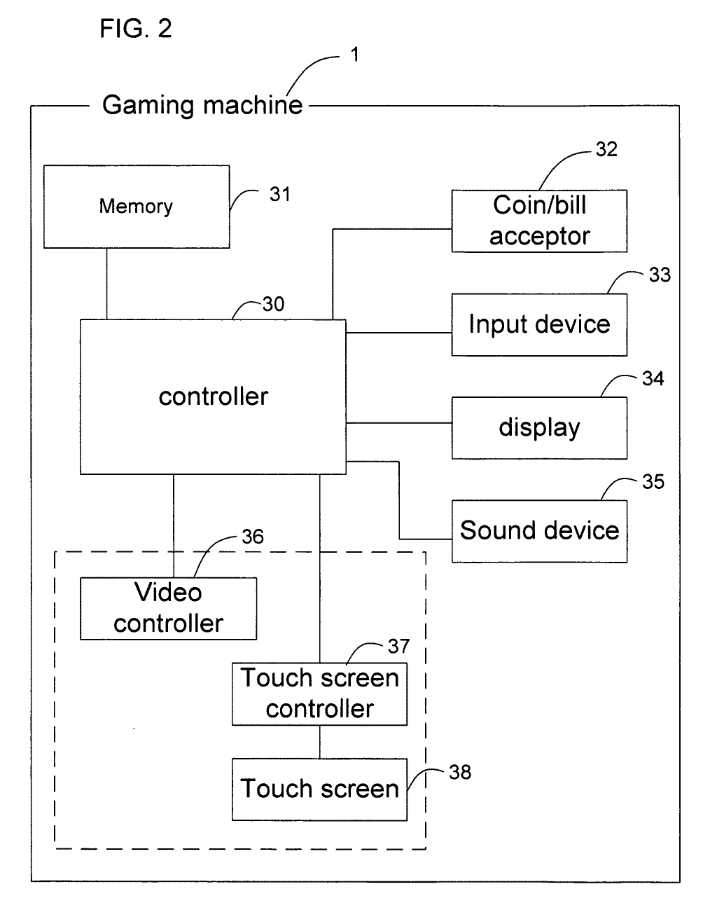

FIG. 2 is a block diagram illustrating an example of an operational structure of the gaming machine 1 of the present invention. The gaming machine 1 is configured with a controller 30, a memory 31, a coin/bill acceptor 32, an input device 33, a display 34, a sound device 35, a video controller 36, a touch screen controller 37 and a touch screen 38. The controller 30 executes a game program for conducting the primary game and the secondary game. The memory 31 stores information regarding a game status, a game program and data, etc. The coin/bill acceptor 32 equipped as the coin slot 8 and the bill acceptor 9 of FIG. 1 receives a coin or a bill from a player. The input device 33, which is equipped as the BET switches 4, the selection switches 5, the MAXBET switch 6, the PAYOUT switch 7 and the spin button 11 of FIG. 1, receives an operation from the player and transmits the operation to the controller 30. The display 34 corresponding to the display 2 in FIG. 1 indicates information regarding a game. The sound device 35 can be used to make a sound to excite or entertain the player. The video controller 36 may be used to process a game image to be displayed on the display 34. The touch screen controller 37 controls the touch screen 38, which can be disposed over the display 2 in FIG. 1 to receive an operation from the player. The controller 30 is connected to the memory 31, the coin/bill acceptor 32, the input device 33, the display 34, the sound device 35, the video controller 36 and the touch screen controller 37 to process information received from these component parts and control them to carry out the game provided by the gaming machine 1.

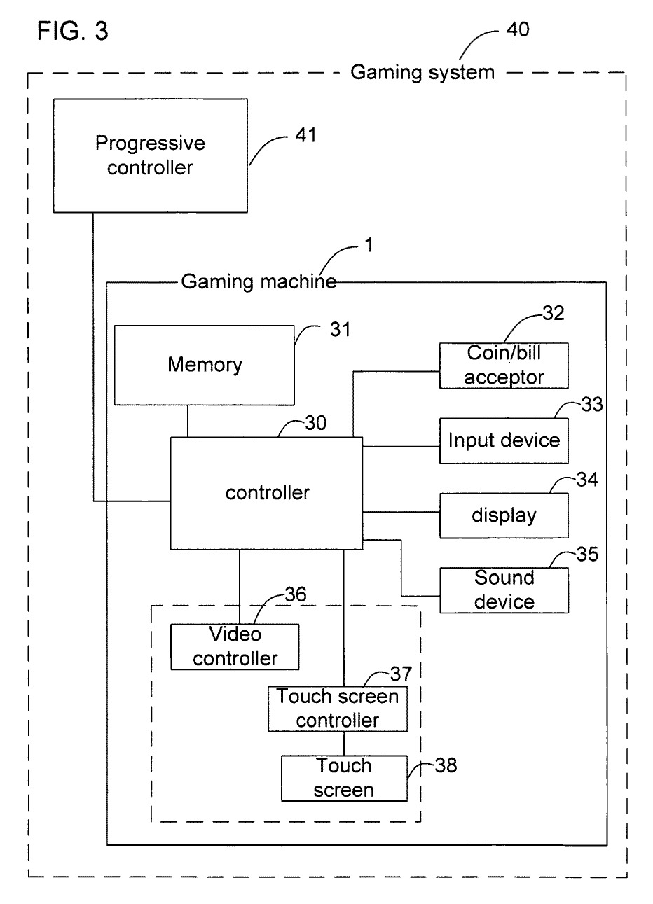

FIG. 3 is a block diagram illustrating an example of a gaming system of the present invention. As shown in FIG. 3, the gaming system 40 includes a progressive controller 41 and the gaming machine 1. The gaming machine 1 functions as described above with reference to FIG. 2. The progressive controller 41 is connected to the controller 30 equipped in the gaming machine 1. The progressive controller 41 plays a role to increase the amount of the progressive award on the basis of the bet from the player and pay out the progressive award according to a result of the secondary game executed by the gaming machine 1.

Concretely, the controller 30 receives a bet signal from the coin/bill acceptor 32 after the coin/bill acceptor 32 receives money from the player. The controller 30 transmits the bet signal to the progressive controller 41. The progressive controller 41 increases the amount of the progressive award on the basis of the bet signal. The controller 30 executes the game while the progressive controller 41 increases the amount of the progressive award. If a predetermined condition is met in the secondary game executed by the controller 30, the controller 30 transmits a signal to the progressive controller 41 and the progressive controller 41 pays out the progressive award to the player. It should be noted here that although only one gaming machine 1 is connected to the progressive controller 41 in FIG. 3, two or more gaming machines 1 may be connected to the progressive controller 41. In the case where a plurality of gaming machines 1 are connected to the progressive controller 41, the progressive controller 41 may increase the amount of the progressive award on the basis of the bet signal sent from each of the plurality of gaming machines 1. Also, in the case where the gaming machine 1 is configured as a stand-alone progressive gaming machine, the functions of the progressive controller 41 described above may be carried out by the controller 30 of the gaming machine 1.

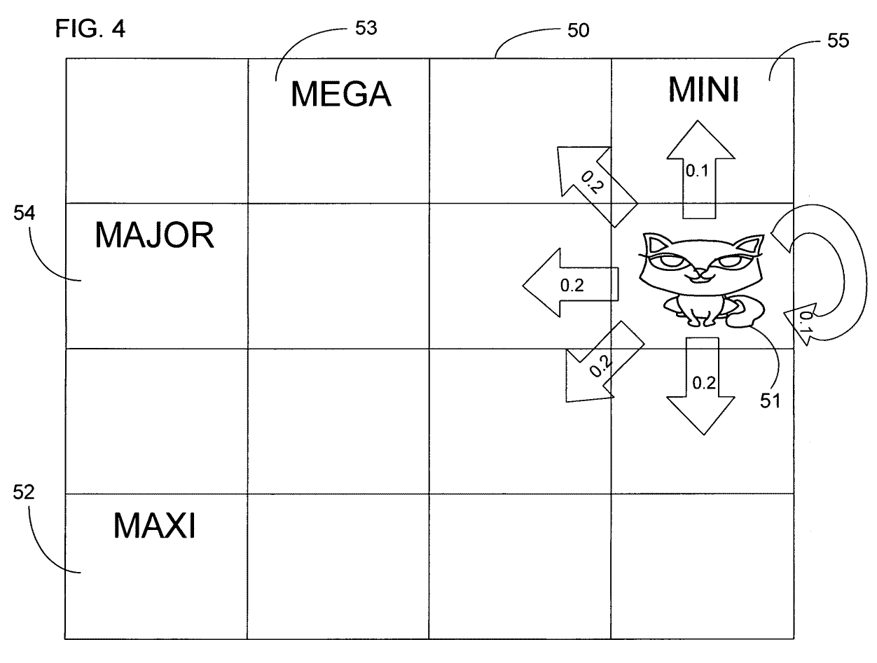

FIG. 4 is a diagram illustrating a state of an exemplary game executed by the gaming machine 1 as a secondary game. Specifically, FIG. 4 shows an example of a graphical content shown in the display 2 in the secondary game. As shown, a grid 50 is provided to define a plurality of rectangular cells or tiles arranged in a form of a 4×4 matrix in the display 2, and a character 51 (it is also called a selector in this specification) is indicated in one of the cells of the grid 50. The initial position of the character 51 when the secondary game is first entered may be randomly determined by the controller 30 or may be at a predetermined position determined by the game designer. The character 51 is caused to move on the grid 50 when a predetermined condition is met in the primary game, as described in detail later, to select a cell or more precisely, indicate the selected cell. The character 51 may move in any direction on the grid 50 but the direction to which the character 51 moves is preferably determined by using a random number. Specifically, in this embodiment, each cell in the grid 50 is provided with a probability function defining a probability that the character 51 will move from the cell to each of the respective cells in the grid 50 when the character 51 resides in the cell, and the controller 30 determines the cell to which the character 51 moves based on the random number and the probability function associated to the cell in which the character 51 is currently positioned (the cell in which the character 51 is currently positioned may be referred to as a “current cell” hereinafter). In the example shown in FIG. 4, the character 51 is positioned in the second top cell in the right-end column, and the probability function associated to this cell sets a probability that the character 51 will move to (or stay in) the same cell at 0.1, a probability to move to its upper adjoining cell at 0.1, and a probability to move to each of its other adjoining cells (i.e., upper left cell, left cell, lower left cell and immediately underside cell) at 0.2, as shown by the numbers indicated in the arrows in FIG. 4. It will be understood that though not explicitly shown in the drawing, the probabilities to move to the other cells (i.e., cells not adjoining the current cell) are set to zero in the example of FIG. 4 because the total of the shown probabilities is one (1). Thus, in this example, the character 51 cannot “jump” to a cell not adjoining the current cell in a single move. However, in other embodiments, there may be a non-zero possibility that the character 51 may move to a cell not adjoining the current cell. Also, the probability function assigned to each cell may be dynamically changed instead of being fixedly determined. The image of the character 51 may be modified or animated to show some emotional expressions linking to the result of the game, such as smiling or crying, to make the game more fun and entertaining to the player. Furthermore, due to the use of random number in determining the movement of the character 51, the player cannot predict the movement of the character 51, which can enhance the excitement of the player. Accordingly, the use of the character moving on the grid 50 as a selector for visually indicating the selected cell gives more fun to the game.

In the embodiment of FIG. 4, four award levels “MAXI, MEGA, MAJOR and MINI” of the progressive award are allocated to cells 52, 53, 54 and 55, respectively, of the grid 50. The allocation of these award levels to some of the cells in the grid 50 may be randomly determined when the secondary game is first entered or at any other appropriate timing, or may be predetermined by the game designer. When the character 51 stops at one of those cells 52, 53, 54 and 55 allocated with an award level, a prize corresponding to the allocated award level is paid out to the player in the secondary game as an execution of a process according to the allocated award. For example, the MINI award is paid out to the player when the character 51 moves to and stops on the cell 55 to which the “MINI” award is allocated.

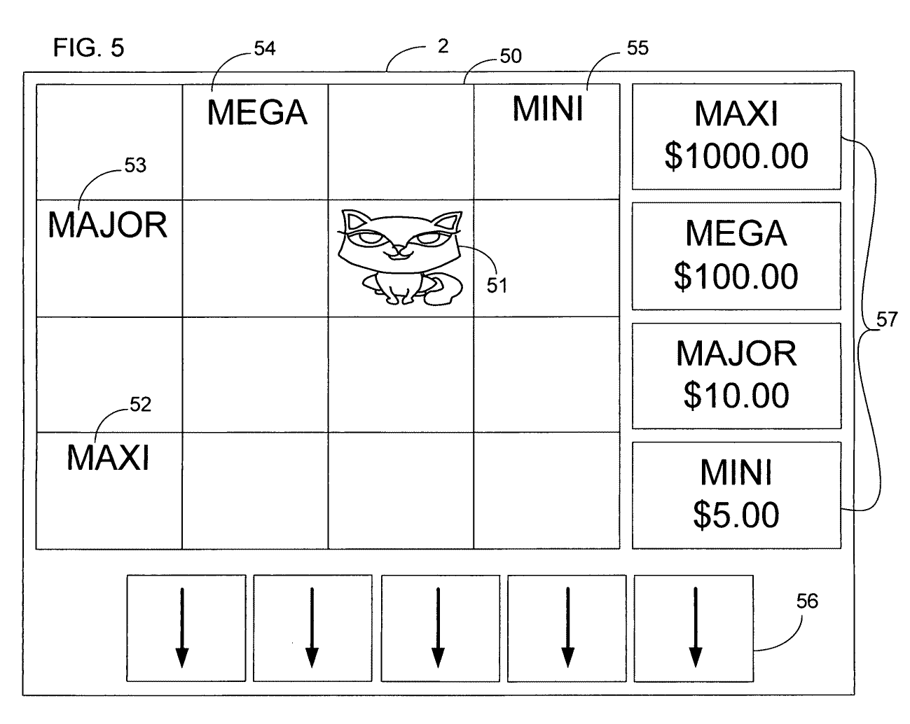

FIG. 5 is a diagram illustrating a state of an exemplary game executed by the gaming machine pertaining to the present invention. Specifically, FIG. 5 illustrates an example of a game screen that, in addition to the grid 50 shown in FIG. 4, contains reels 56 for conducting a slot game as a primary game and an area 57 for showing the amount of progressive award containing four progressive award levels MAXI, MEGA, MAJOR and MINI. As described above with reference to FIG. 4, the four levels of progressive award “MAXI, MEGA, MAJOR and MINI” are allocated to certain cells 52, 53, 54 and 55, respectively. The progressive award display area 57 is provided in a right hand side on the display 2. The amount of each progressive award level is increased by the progressive controller 41 based on the amount of the bet from the player. Also, the game screen of FIG. 5 contains five reels 56 for displaying symbols at the bottom on the display 2. In a slot game, the five reels 56 are rotated as indicated by downward arrows in each reel 56 in FIG. 5, and then stopped by the controller 30 to indicate one or more combinations of symbols. It should be noted that though only one symbol is usually displayed by each reel 56 when the rotation of reel 56 is stopped, the number of symbols displayed by each reel 56 may not be limited to one, and two or more symbols may be displayed. Also, the reels 56 may be mechanical or video reels.

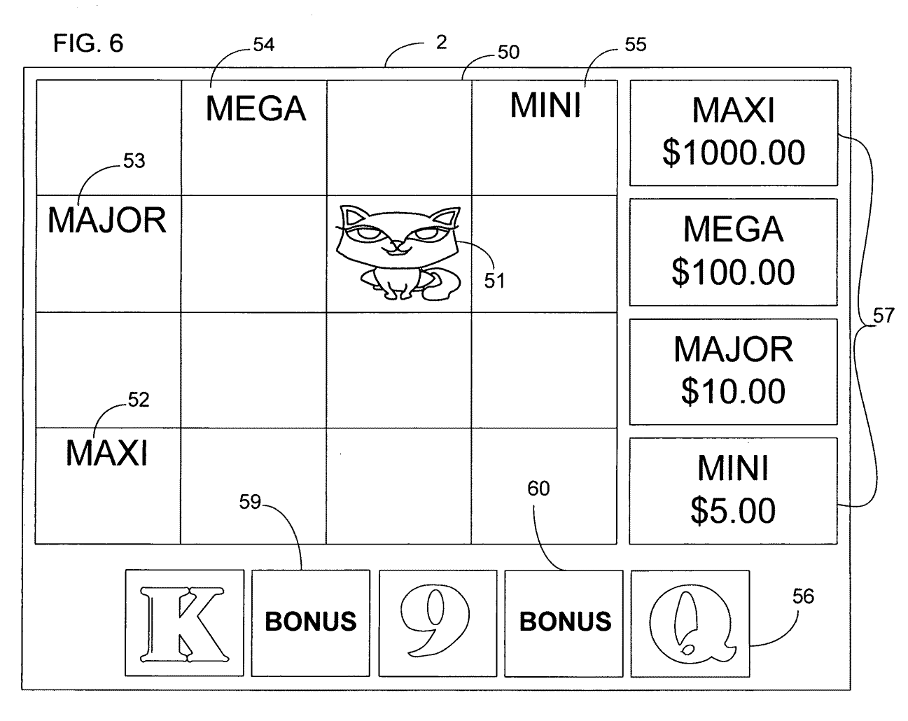

FIG. 6 is a diagram illustrating a state to which the game state shown in FIG. 5 has progressed further. In FIG. 6, the state in which the symbols are displayed by the reels 56 is shown. Four different kinds of symbols, i.e., “K”, “BONUS”, “9” and “Q”, are displayed by the reels 56. Two bonus symbols (“BONUS”) are shown by two reels 59 and 60. In this embodiment, a bonus symbol can trigger the secondary game and in the secondary game, the character 51 is caused to move on the grid 50 a number of times corresponding to the number of bonus symbols appearing on the reels 56. Therefore, in the shown example, the character 51 is caused to move twice.

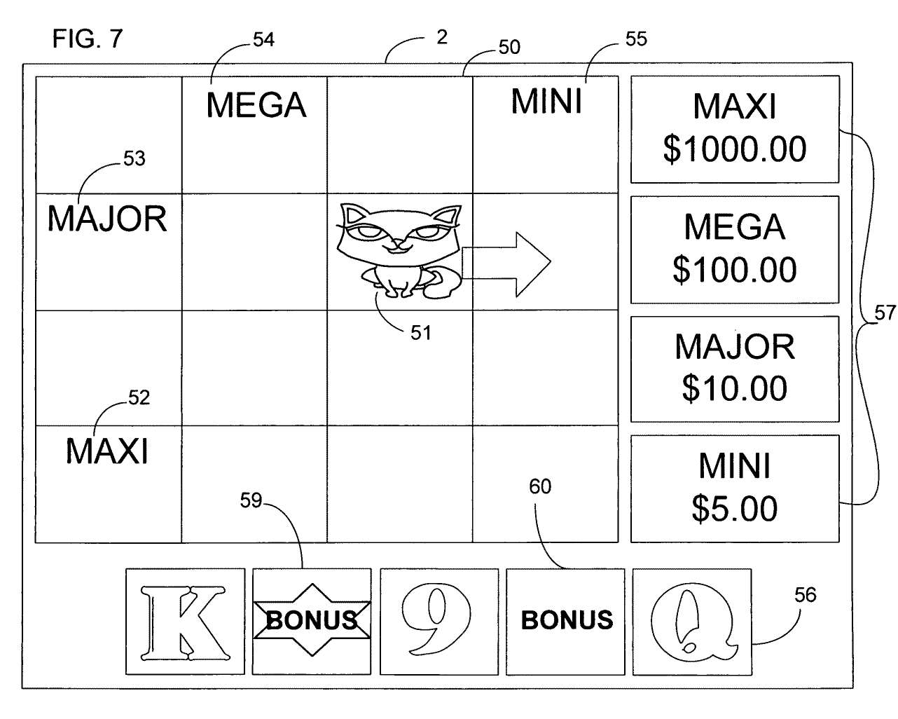

FIG. 7 is a diagram illustrating a state to which the game state shown in FIG. 6 has progressed further. In FIG. 6, two bonus symbols are displayed by the reels 59 and 60. In the state of FIG. 7, in response to the first bonus symbol shown by the reel 59, a first move of the character 51 is being conducted. In this example, a cell on the right-side of the current cell is selected by the controller 31 based on a random number and the probability function associated to the current cell, and accordingly the character 51 moves to the right-side cell (i.e., the second top cell in the right-end column), as shown by an arrow in FIG. 7. Because the cell to which the character 51 moves is not associated with an award, no prize is paid to the player in response to the first move of the character 51.

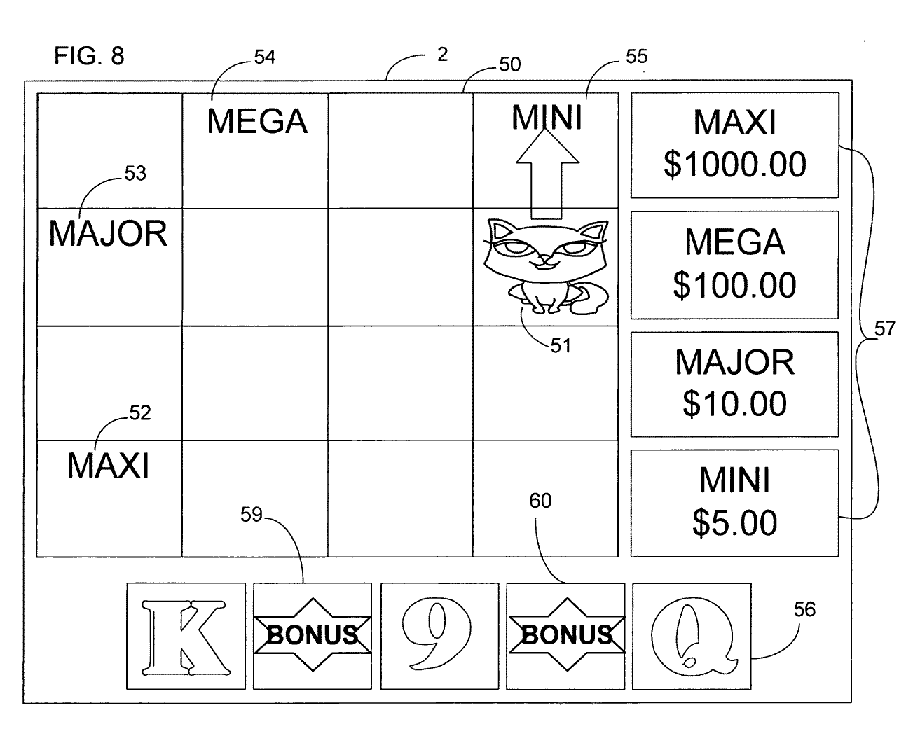

FIG. 8 is a diagram illustrating a state to which the game state shown in FIG. 7 has progressed further. FIG. 8 illustrates a state where a second move of the character 51 is being conducted corresponding to the second bonus symbol shown by the reel 60 after the first move has finished. In this example, a cell on top of the current cell is selected by the controller 31 based on a random number and the probability function associated to the current cell (which, at this time, is the second top cell in the right-end column), and accordingly the character 51 moves up to the upper-side cell (i.e., the cell at the upper right corner of the grid 50), as shown by an arrow in FIG. 8.

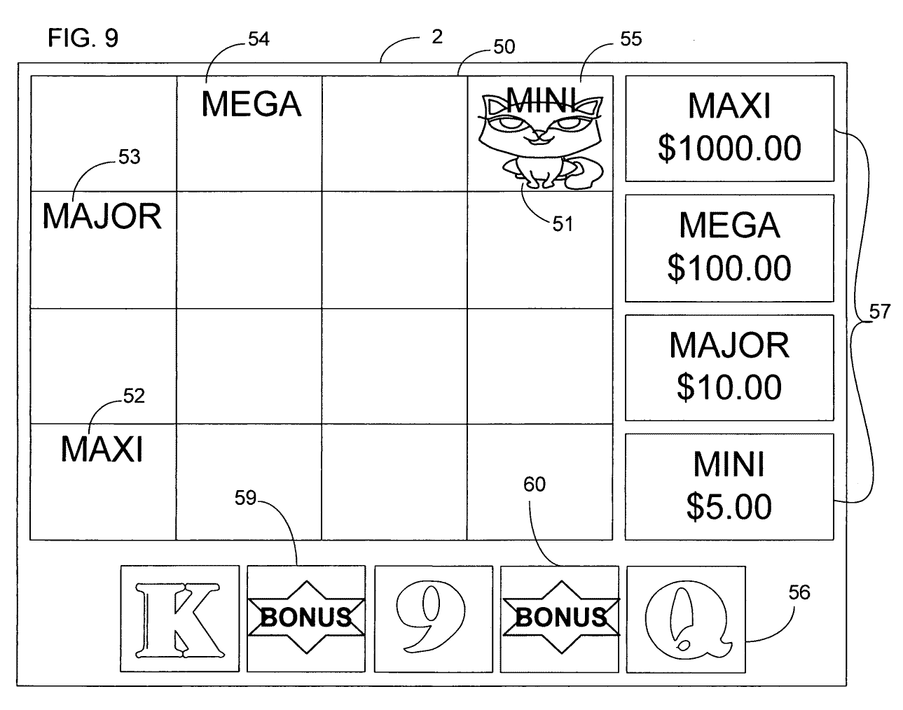

FIG. 9 is a diagram illustrating a state to which the game state shown in FIG. 8 has progressed further. FIG. 9 illustrates the state in which the character 51 has finished the movements corresponding to the two bonus symbols displayed by the reels 59 and 60. In the state of FIG. 9, the character 51 ends up in the cell 55 associated with the MINI progressive award. Therefore, the progressive controller 41 pays out the amount of the “MINI” award to the player. As will be appreciated, in the case where the character 51 ends up in the cell 52, 53 or 54 associated with the MAXI, MEGA or MAJOR progressive awards instead of the cell 55 associated with “MINI” award, the progressive controller 41 pays out the respective award associated to the cell 52, 53 or 54.

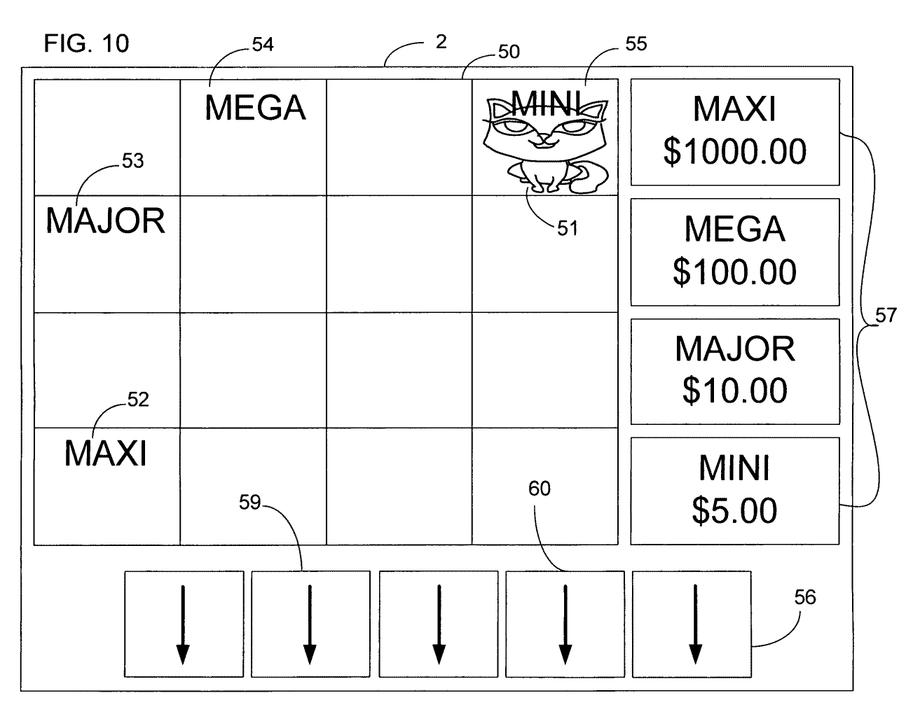

After paying out the prize to the player, upon the player's instruction, the controller 30 starts to spin the reels 56 to conduct the primary game (slot game) again, as shown in FIG. 10. It should be noted here that in FIG. 10, the character 51 is shown to be positioned in the cell selected in the last secondary game. In other words, the result of the last secondary game inclusive of information regarding the cell selection has been stored so that the information is used to display the character 51 during the primary game.

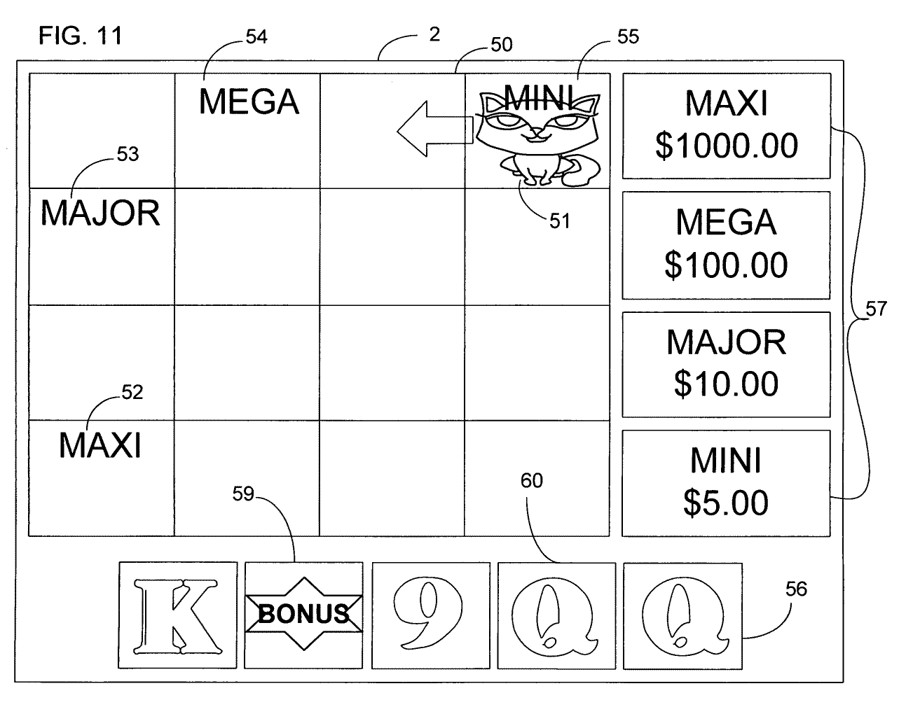

If the bonus symbol is shown by any of the reels 56 when the rotation of the reels 56 stops, the secondary game is conducted to move the character 51 to a cell selected by the controller 31. In FIG. 11, the bonus symbol is displayed only by the reel 59 and correspondingly, the character 51 is moved only once. As described above, the controller 30 selects the cell to which the character 51 moves based on a random number and the probability function associated with the cell in which the character 51 is currently positioned. It should be noted here that the cell in which the character 51 is currently positioned is the one that was selected in the previous secondary game. Thus, the result of the previous secondary game including the information regarding cell selection is used in the current secondary game. In the example of FIG. 11, the cell on the left side of the current cell is selected and the character 51 is moved to this cell, as shown by an arrow. The selected cell to which the character 51 moves is not associated with an award, and therefore no prize is paid out to the player in this secondary game. However, because the character 51 has moved closer to the cells 52, 53 and 54 allocated with the awards MAXI, MAJOR and MEGA, respectively, the player can have a feel that the probability of winning the award has increased and thus is encouraged to continue to play the game longer. This is particularly true when the probability function of each cell is defined such that the character 51 can only move to a cell adjoining the current cell or stay in the current cell in a single move (i.e., cannot jump to a cell not adjoining the current cell), because in such a case the chance that the character 51 will move to the award-allocated cells in a few games apparently depends on the distance between the character 51 and the award-allocated cells.

As described above, in the above embodiment, a plurality of areas (cells) are defined in the display, and an award (MAXI, MEGA, MAJOR, MINI) is allocated to at least one of these areas, and when a cell allocated with the award is selected, a prize according to the award is paid out to the player. Also, the result of the secondary game including the information regarding the cell selection is passed to and used in the next secondary game. Thus, the player can feel like to play the game longer when the result of the secondary game may appear to lead to a higher chance of winning an award in the next secondary game. Particularly, in the above embodiment, an object such as the cat-character 51 arranged to randomly move from one area to another is used to visually indicate the selected area, and this may give an impression to the player that the object is moving toward an area or areas allocated with an award little by little according to the progress of the game. Thus, this arrangement of the secondary game can provide the player with an expectation of high chance of winning an award and excitement resulting from such an expectation.

The present invention is not limited to the embodiment illustrated in FIGS. 4 through 11. For instance, the cells defined by the grid 50 are not limited to an arrangement of “4×4” matrix, but may be arranged in any pattern of matrix. The cells may be arranged in “3×3” matrix, “4×5” matrix, “5×4” matrix or “5×5” matrix, for example. Further, the cells may not be necessarily arranged in a matrix pattern but may be arranged in any pattern. For example, the cells may be arranged to form five columns such that the first, third and fifth columns from the left each contain three cells while the second and fourth columns each contain four cells. In this case, the cells are not arranged in line in a horizontal direction (i.e., in a direction perpendicular to an extension of columns). Further, the shape of each cell may not be limited to the rectangular shape, but may be of any shape such as circle, square or any other polygonal shape. The cells may or may not contact adjoining cells.

The number of the progressive levels is not limited to four, but may be any number. The number of the progressive levels may be five or more, or three or less. All the progressive levels in the game may be displayed on the grid 50. Alternatively, only several levels out of all the progressive levels in the game may be displayed on the grid 50. The character 51 may be arranged to jump over one or more cells to move to cells apart from the current cell in one movement.

The display which shows a graphic content indicating the character 51 may be separated from the display which shows the reels 56 indicating symbols. For example, the upper display on the gaming machine 1 may be used to show the graphic content indicating the character 51, while the lower display on the gaming machine 1 may be used to show the reels 56 indicating symbols. Further, the trigger for conducting the secondary game (or selecting a cell and moving the character 51 to the selected cell) is not limited to only when the bonus symbol appears in the primary game. Another kind of symbol can be a trigger for starting the secondary game. Moreover, the secondary game may be triggered when two or more bonus symbols or any other predetermined symbols appear on the reels 56. The trigger for starting the secondary game may be independent from the result of the primary game. The number of reels 56 is not limited to five as shown in above FIGS. 4-11, but may be any number.

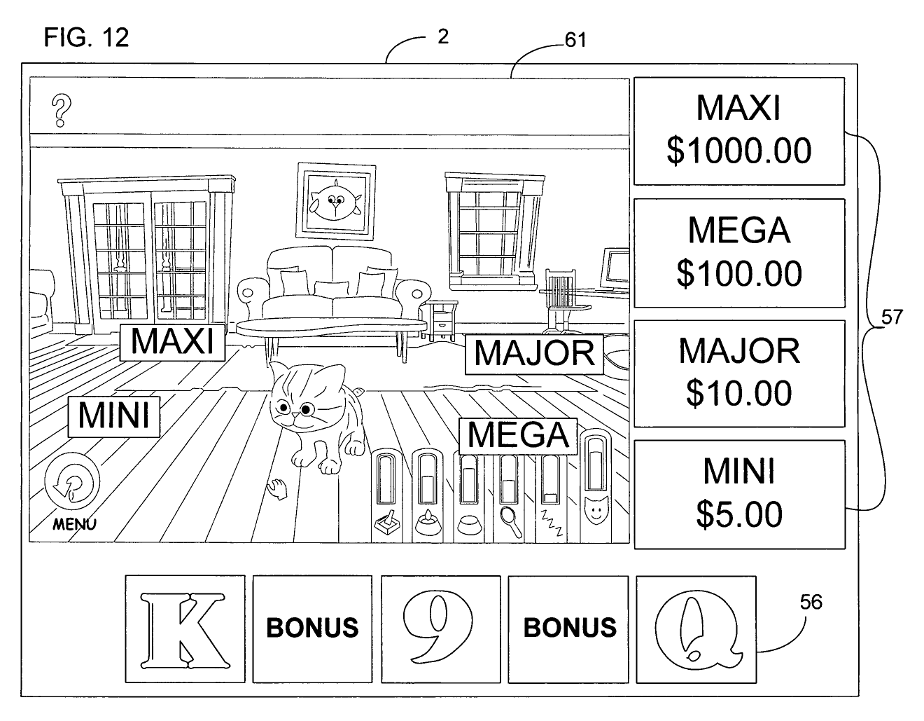

FIG. 12 is a diagram illustrating another example of the game executed by the gaming machine 1 pertaining to the present invention. In FIG. 12, a three-dimension image 61 representing a room is displayed instead of the grid 50. Also, a three-dimensional cat character is displayed so as to be movable in the room instead of moving on the grid 50. The cat character is caused to move when a predetermined symbol, such as the bonus symbol etc., appears in the reels 56. It should be noted that a plurality of areas are defined in the image 61 although border lines of the areas are not visually shown in the image 61, and four progressive award levels “MAXI, MEGA, MAJOR and MINI” are allocated to some of the areas, as indicated by the icons in the image 61. When the cat character moves to and stops on an area allocated with one of the award levels, the prize corresponding to the award level is paid out to the player. Thus, the gaming machine 1 of the present invention can be applicable to three dimensional images instead of two dimensional ones.

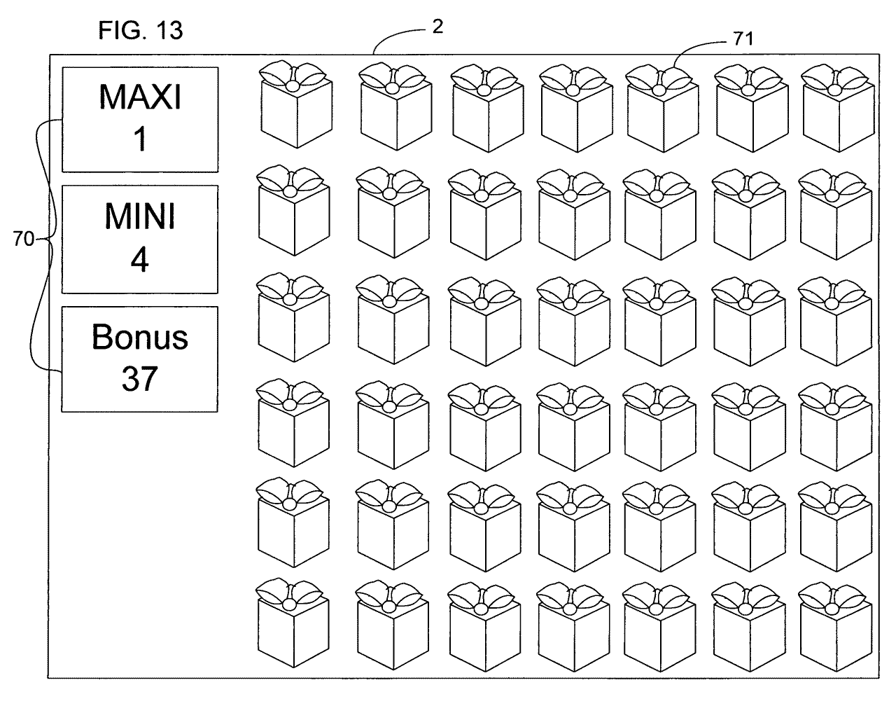

FIG. 13 is a diagram illustrating another example of a game executed by the gaming machine 1 pertaining to the present invention. This game is designed as a so-called “treasure game” and is preferably carried out as a secondary game, which can be triggered when a predetermined condition is met during the primary game. As shown in FIG. 13, a plurality of boxes 71 are shown on the display 2 in the secondary game. Specifically, the number of the boxes 71 on the display 2 is forty-two in the illustrated example. Each box 71 has a corresponding area defined in the display 2 and is allocated with an award. Specifically, one “MAXI” award, four “MINI” awards and thirty-seven “Bonus” awards are allocated to those boxes 71 randomly. Such an allocation can be performed by using random numbers when the secondary game is entered. The number of those awards is indicated in an award display area 70 in a left portion of the display 2. However, there is no information displayed regarding the concrete allocation of the awards to the boxes 71, or the awards are concealed among the boxes 71, and therefore the player cannot know which award is allocated to which box. The gaming machine 1 is designed to allow the player to choose a box in the secondary game. The choice of box by the player can be preferably achieved by using the touch screen 38 disposed over the display 2.

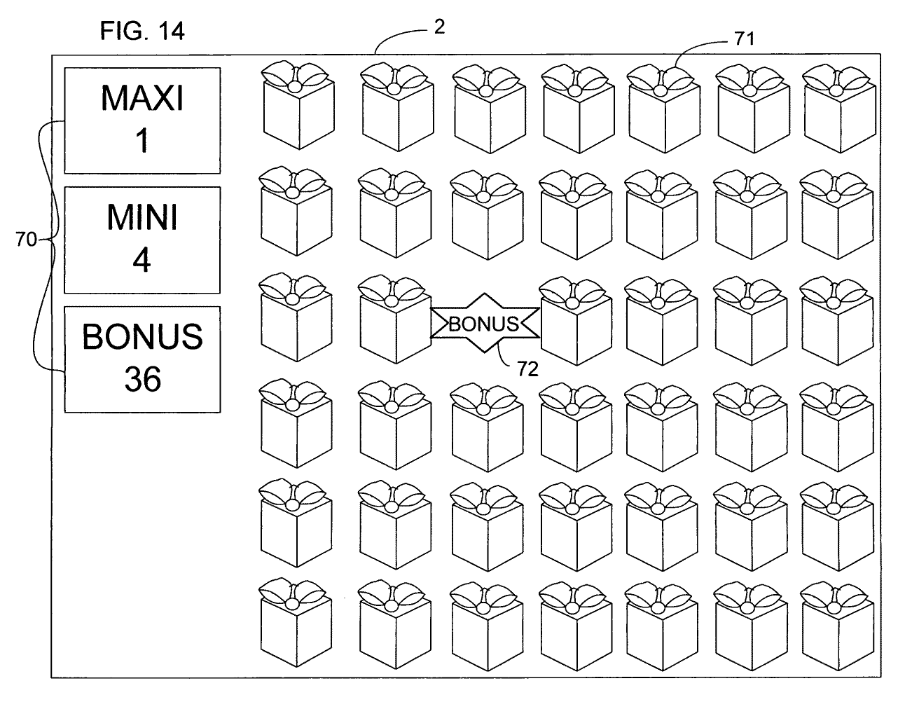

FIG. 14 is a diagram illustrating a state to which the game state shown in FIG. 11 has progressed further. This figure illustrates the state that the player has chosen a box 72. In response to the player's choice, the box 72 is opened and an award mark “Bonus” comes out of the box 72, and the player is given a corresponding bonus prize, which may be a fixed value such as $5, for example. It should be noted here that “MINI” and “MAXI” awards may be progressive awards, which when being hit, pay out a prize much higher than when the “BONUS” award is hit. In this embodiment, the “MAXI” award has a higher start up value and average winning prize than “MINI” award, and thus is the most valuable award available in the secondary game. As the award mark “Bonus” comes out and the corresponding bonus prize is given to the player, the number of the award mark “Bonus” (or the number of the non-selected boxes to which the “Bonus” award” is allocated) on the indication 70 decreases by one and becomes thirty six from thirty seven.

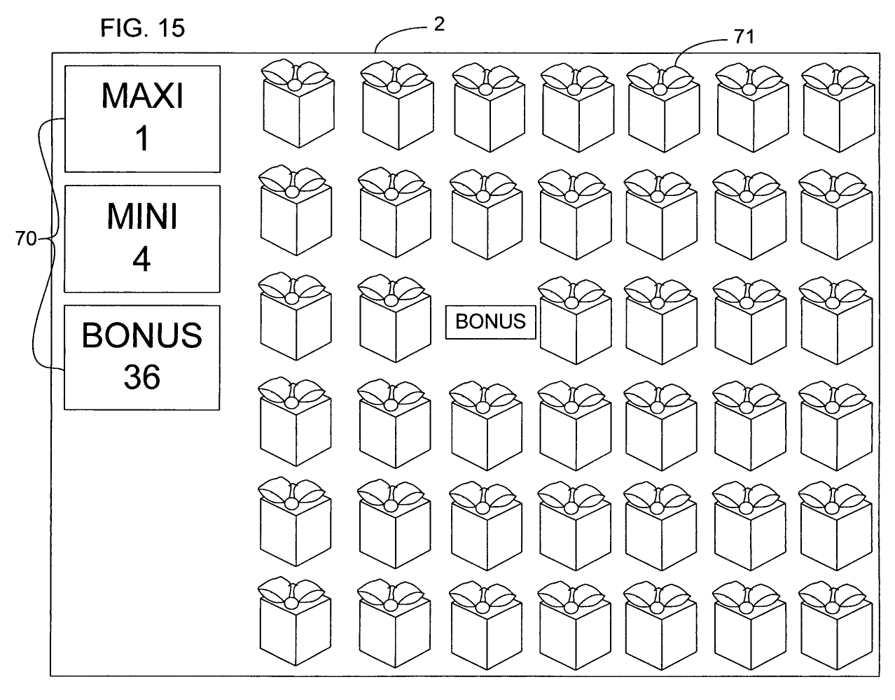

FIG. 15 is a diagram illustrating a state to which the game state shown in FIG. 12 has progressed further. After the secondary game is executed as explained in FIG. 14, the primary game is resumed again. The result of the secondary game as shown in FIG. 14 is stored in the memory 31. The result contains information regarding the selected cell and the award allocated to the selected cell. The result of the secondary game may be shown on the display 2 while the primary game is executed. FIG. 15 illustrates a state that the display 2 is indicating the result of the secondary game while the primary game is being executed. Thus, the player can confirm the result of the last secondary game any time.

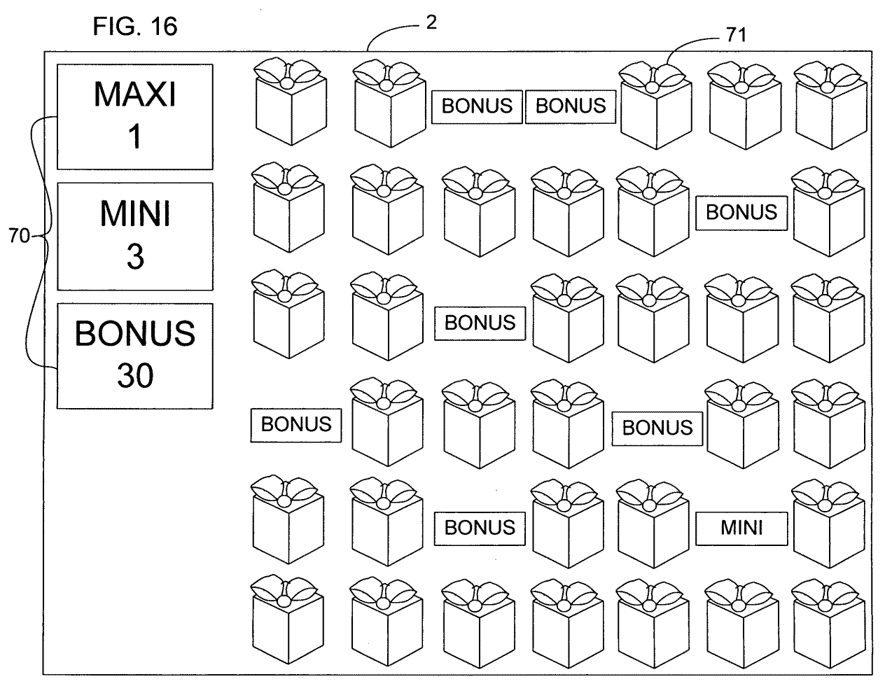

FIG. 16 is a diagram illustrating a state to which the game state shown in FIG. 15 has progressed further. FIG. 16 illustrates the state after the player has chosen a plurality of boxes 71 as a result of execution of several secondary games. The plurality of boxes which the player has chosen are opened and, in this example, seven “Bonus” awards and a “MINI” award appear on the display 2. Thus, in this embodiment of the present invention, the result of each secondary game including the choice of box is passed to the subsequent secondary game so that when a new secondary game is executed, the results of the past secondary games are reflected in the new secondary game. In response to the appearance of seven “Bonus” awards and one “MINI” award, the player is given corresponding prizes and the number of the “Bonus” award indicated in the award display area 70 becomes thirty and the number of the “MINI” award becomes three. Thus, the indication of the award display area 70 is kept updated to show the remaining number of each kind of award (or the number of non-selected cells to which each kind of award is allocated). With such an indication, it is easy for the player to see which award level has been obtained and which award level the player can earn by continuing the game. Thus, the more boxes allocated with “BONUS” mark selected, the player can expect a higher chance to select a box allocated with the “MAXI” award for the subsequent secondary game, and this can give the player an incentive to continue the game for a longer period of time.

It should be noted that the number of boxes which the player can choose at a time (or in one secondary game) is not limited to one, but may be two or more.

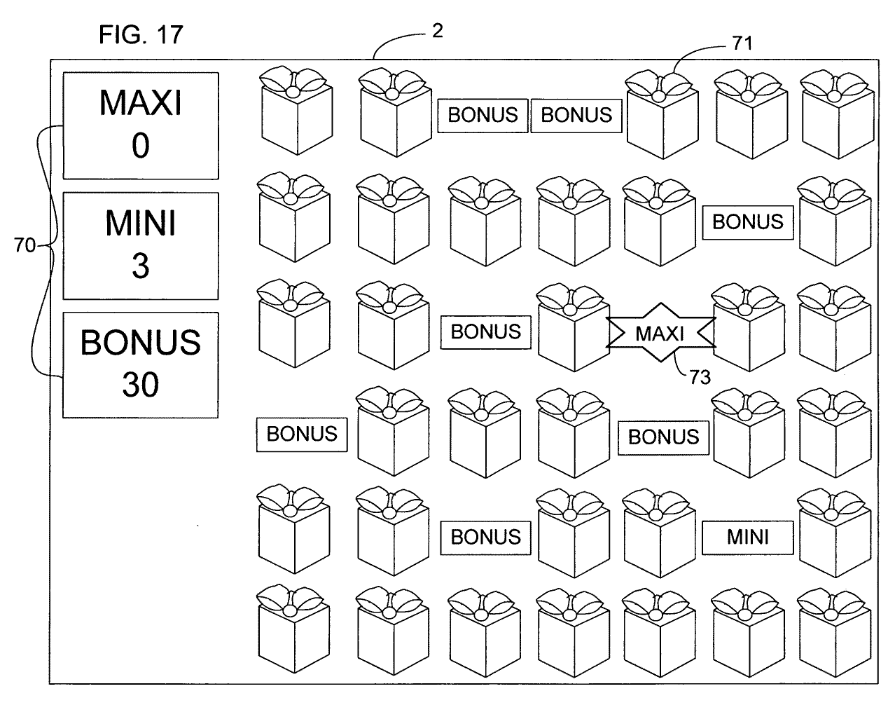

FIG. 17 is a diagram illustrating a state to which the game state shown in FIG. 16 has progressed further. FIG. 17 illustrates a case in which the player has chosen a box allocated with “MAXI” award and a star-shaped mark 73 having a letter “MAXI” is shown. At this moment, the amount of credit worth of the “MAXI” award is paid out to the player.

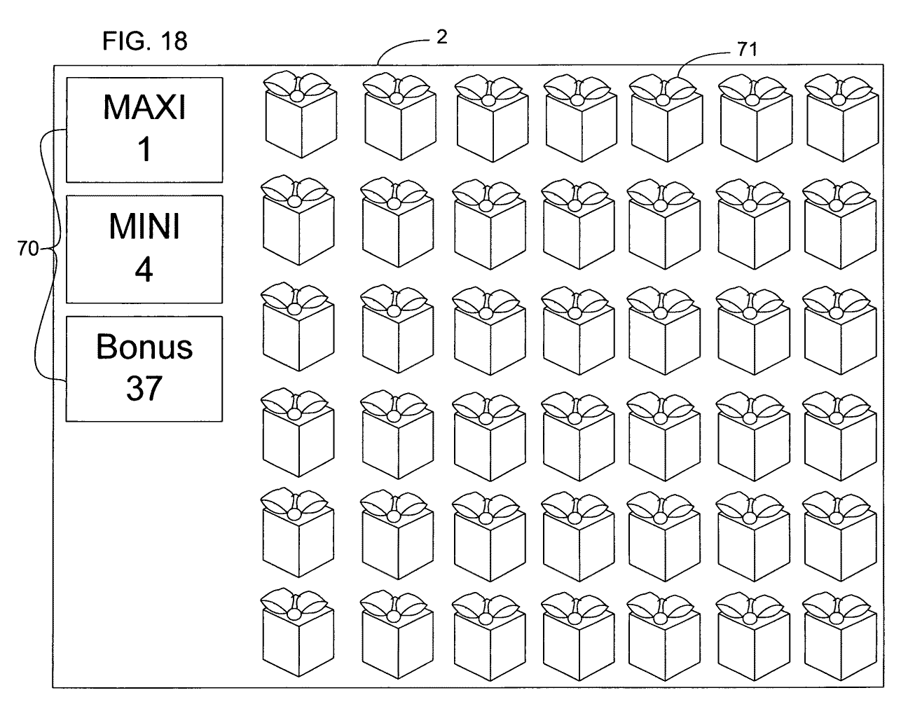

FIG. 18 is a diagram illustrating a state to which the game state shown in FIG. 17 has progressed further. FIG. 18 illustrates a state after the player has chosen the cell allocated with “MAXI” award, which is the most valuable award available in the secondary game in this embodiment. In FIG. 18, the game status of the secondary game is reset and the display 2 indicates an original status of the secondary game, in which all the boxes 71 are closed and the number of each kind of awards shown in the award display area 70 is reset to the initial value. Also, the awards (MAXI, MINI and BONUS) are reallocated to the boxes 71 randomly by using random numbers. Thus, in this embodiment, the game state is reset when the “MAXI” award (or the most valuable award) is won by the player. Alternatively, the secondary game may not be reset in response to the player's selection of the box allocated with the “MAXI” award (or the most valuable award) but may be reset in response to other conditions such as when a predetermined number of secondary games have been conducted or a predetermined number of boxes have been opened, for example.

The present invention is not limited to the embodiments explained above referring to FIGS. 13 through 18. For example, the number of boxes 71 may be any number. The number of each kind of awards is not limited to these numbers illustrated above. Two or more “MAXI” awards may be allocated and five or more “MINI” awards may be allocated. The boxes 71 may not be arranged in the matrix pattern but may be arranged in any pattern in the display 2. Also, there may be a box 71 allocated with no award.

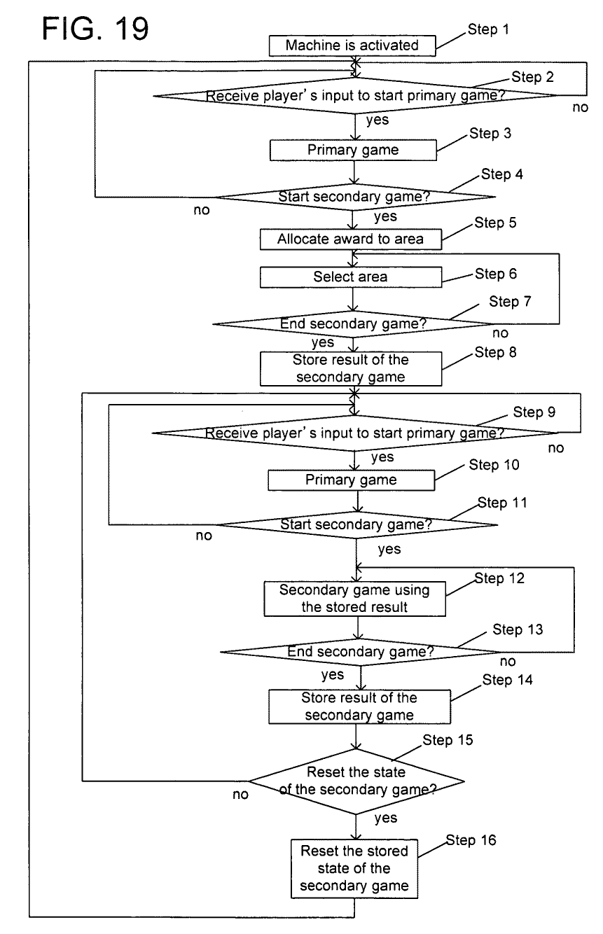

FIG. 19 is a flowchart illustrating an example of an operation of the gaming machine 1 pertaining to the present invention to perform a game. FIG. 19 indicates a simplified operation of the present invention. First, the gaming machine 1 is activated when the gaming machine 1 is powered on (step 1). The controller 30 waits for an input from the player to start the primary game (step 2). When the controller 30 receives the input from the player, the controller 30 starts and executes the primary game (step 3) based on a random number, which may be generated either after or before the controller 30 receives the input from the player to start the primary game. When the controller 30 does not receive the input from the player, it does not start the primary game until receiving the input.

Next, the controller 30 determines whether or not a predetermined condition for starting the secondary game is satisfied in the primary game (step 4), and proceeds to step 5 if the predetermined condition is met. As described above, a plurality of areas are defined on the display 2 in the secondary game, and the controller 30 allocates one or more awards preferably including a progressive award to those areas (step 5). Those areas, for example, may be embodied as the cells of the grid 50, the boxes 71, etc. After allocating, an area is selected by the controller 30 (step 6). The area may be selected automatically by the controller 30 using a random number. Such a way of area selection is preferable in the case where the information regarding the allocation of awards to the areas is visually indicated in the display, as illustrated in the embodiment shown in FIGS. 4-12. Alternatively, the player may designate an area on the display 2 by using a touch screen, for example, and the controller 30 may select the area according to the designation by the player. Such a way of area selection is preferred in the case where the information regarding the allocation of awards to areas is not visually indicated in the display (in other words, the awards are concealed), as illustrated in the embodiment shown in FIGS. 13-18. Then, when the selected area is allocated with an award, the amount of credit worth of the award is calculated and paid out to the player.

After the above step, the controller 30 determines whether or not the secondary game is ended (step 7). When the controller 30 determines that the secondary game is ended, a result of the secondary game is stored in the memory 31 as an electronic data (step 8). The electronic data, for example, may include a state after the area has been selected, which may be displayed on the display 2. On the other hand, when the controller 30 determines that the secondary game is not ended, the controller 30 continues to execute the step of the area selection (step 6).

After storing the result of the secondary game, the controller 30 stands ready to receive an input from the player to resume the primary game (step 9). When the controller 30 receives the input from the player, it resumes the primary game again (step 10). When the controller 30 does not receive the input from the player, it continues to stand ready to resume the primary game. Then, the controller 30 determines whether a predetermined condition for entering the secondary game is satisfied in the primary game in step 11, and if it is found that the condition is met, the controller 30 starts executing the secondary game by using the stored electronic data including the result of the previous secondary game, which may be displayed in the display 2 (step 12). If the predetermined condition is not satisfied, the process goes back to step 9 where the controller waits for the player's input. In the secondary game of step 12, an area is selected and if the selected area is allocated with an award, a prize corresponding to the award is paid out to the player. Concretely, the controller 30 displays the state after the area has been selected on the display 2. If the selected area is allocated with an award, an indication of the award may be shown on the selected area to the player.

After step 12, the controller 30 determines whether or not the secondary game is ended (step 13). When the controller 30 determines that the secondary game is ended, a result of the secondary game is stored in the memory 31 as an electronic data (step 14). On the other hand, when the controller 30 determines that the secondary game is not ended, the controller 30 continues to execute the secondary game (step 12).

After storing the result of the secondary game in step 14, the controller 30 determines whether or not to reset the state of the secondary game (step 15). In one embodiment, the controller 30 determines to reset the state of the secondary game when an area allocated with the most valuable award that can be hit in the secondary game has been selected in the last secondary game. When the controller 30 determines not to reset the state of the secondary game, the process goes to step 9 without resetting the stored result of the secondary game, and the controller 30 stands ready to receive an input from the player to start the primary game. When the controller 30 determines to reset the state of the secondary game, the controller 30 resets the result the stored state of the secondary game in step 16 and the process goes back to step 2 where the controller 30 stands ready to receive an input from the player to start the primary game.

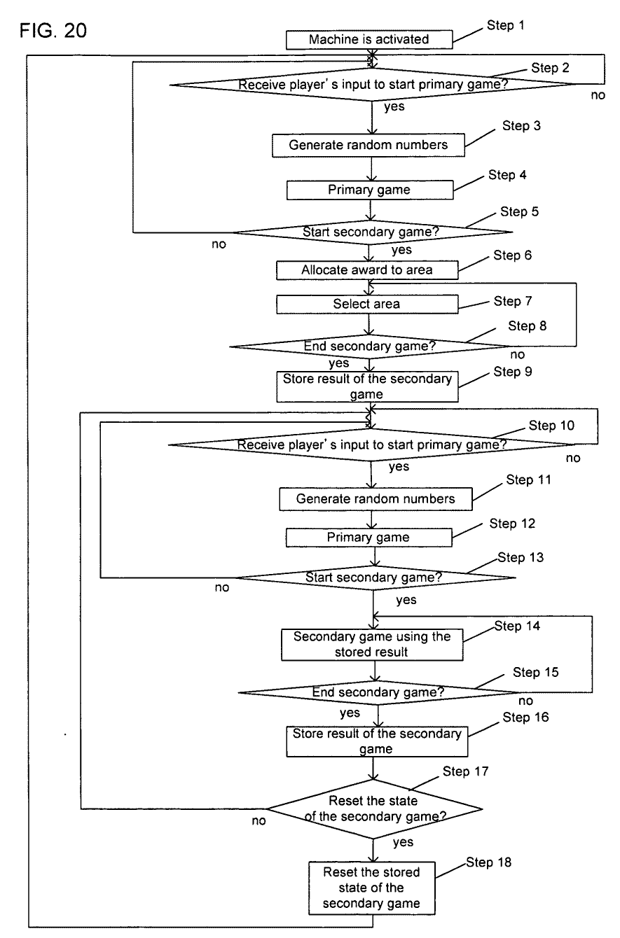

FIG. 20 is a flowchart illustrating another example of an operation of the gaming machine 1 pertaining to the present invention to perform a game. FIG. 20 is the same as FIG. 19 except for the step of generating random numbers at step 3 and 11. In this flowchart, the controller 30 generates random numbers after receiving the input for starting the primary game from the player. The controller 30 determines results of the primary game and the secondary game by using the random numbers. Accordingly, the area where the award is allocated, the area being selected, etc. are determined when the controller 30 has received the input from the player with the random numbers. If the random numbers are used to select an area, the player cannot predict which object is selected to allocate the award. At this point, the random numbers may be generated either after or before the controller 30 receives the input from the player to start the primary game.

In the above description, the present invention has been explained with reference to concrete embodiments. However, it should be understood that the present invention is not limited to the above embodiments and various changes and modifications may be made without departing from the scope of the invention. For example, the slot game, which can be conducted as a primary game, may be executed with either stepper reels (mechanical reels) or video reels. When the stepper reels are used in the gaming machine, the display in the gaming machine may be dual structured. That is, for example, while installing stepper reels in the gaming machine, a transparent type display can be installed on the surface side of the stepper reels. In this way, it is possible to make the symbols on the stepper reels selectively visible to the player by adjusting the transparent type display to a transparent or non-transparent state. It is also possible to display symbols or other visual indications on the transparent type display so as to superimpose or modify the symbols or other visual indications on the stepper reels. For example, a transparent type liquid crystal display, a transparent type organic EL display, etc. can be used as the transparent type display.

Further, the awards allocated to the areas defined in the display may not be limited to those directly specifying the prize paid out to the player. In general, the awards can be anything that may be beneficial to the player, and when an area allocated with an award is selected, the controller executes a process according to the award. For example, the awards may comprise a multiplier so that a prize calculated by multiplying the value of the multiplier with a prize determined by the result of the last primary game may be paid out to the player. Also, it may be possible to provide another bonus game in addition to or as a part of the secondary game, and the awards allocated to areas in the display may contain a bonus trigger for the another bonus game. For example, in the embodiment shown in FIGS. 4-12, the awards allocated to the cells may contain a trigger to the game described with reference to FIGS. 13-18 (i.e., in such a case, the game shown in FIGS. 13-18 serves as the another bonus game).

What is claimed is:

1. A gaming machine comprising:
a display; and
a controller, which a) executes a primary game, b) executes a secondary game in which a plurality of areas are defined on the display such that an award is allocated to at least one of the plurality of areas and when an area to which the award has been allocated is selected, a process according to the award is executed by the controller, and c) stores a result of the secondary game inclusive of information regarding the selected area so that the stored result of the secondary game is used in a next secondary game.

2. The gaming machine of claim 1, wherein the controller stores an amount of progressive award that is progressively increased according to a bet received from a player, and the award allocated to the at least one of the plurality of areas includes the progressive award.

3. The gaming machine of claim 1, wherein a visual indication for indicating the at least one of the plurality of areas to which the award is allocated is shown on the display, and the selection of an area is carried out by the controller based on a random number.

4. The gaming machine of claim 3, wherein the visual indication includes a mark displayed in the at least one of the plurality of areas to which the award is allocated.

5. The gaming machine of claim 1, wherein the controller controls the display to show a selector for visually indicating the result of selection of one of the plurality of areas.

6. The gaming machine of claim 5, wherein the selector includes an object shown on the display, and in the secondary game the controller selects one of the plurality of areas by using a random number and causes the object to move to the selected area.

7. The gaming machine of claim 6, wherein each of the plurality of areas adjoins two or more other areas, wherein the object is caused to move from a certain area to one of its adjoining areas or stay in the same area in a single move.

8. The gaming machine of claim 6, wherein each of the plurality of areas has a probability function associated with it, where the probability function defines a probability that the object will move from the area to each of the plurality of areas when the object resides in the area, and the controller selects one of the plurality of areas by using the random number and the probability function associated to an area in which the object currently resides.

9. The gaming machine of claim 1, wherein information regarding the allocation of the award to at least one of the plurality of areas is not shown on the display and the gaming machine further comprises an interface for allowing the player to select one of the plurality of areas whereby upon the selection of one of the plurality of areas by the player, the controller controls the display to visually show whether the selected area is allocated with the award or not.

10. A gaming system comprising:
a progressive controller, which a) receives a bet and increases an amount of progressive award on a basis of the bet and b) stores the amount of progressive award increased; and
a gaming machine including a display and a controller, which a) executes a primary game, b) executes a secondary game in which a plurality of areas are defined on the display such that an award including the progressive award is allocated to at least one of the plurality of areas and when an area to which the award has been allocated is selected, a process according to the award is executed by the controller, and c) stores a result of the secondary game inclusive of information regarding the selected area so that the stored result of the secondary game is used in a next secondary game.

11. The gaming system of claim 10, wherein a visual indication for indicating the at least one of the plurality of areas to which the award is allocated is shown on the display and the selection of an area is carried out by the controller based on a random number.

12. The gaming system of claim 10, wherein information regarding the allocation of the award to at least one of the plurality of areas is not shown on the display and the gaming machine further comprises an interface for allowing the player to select one of the plurality of areas whereby upon the selection of one of the plurality of areas by the player, the controller controls the display to visually show whether the selected area is allocated with the award or not.

13. The gaming system of claim 10, wherein the progressive award comprises a plurality of progressive award levels and each progressive award level is allocated to one or more of the plurality of areas.

14. The gaming system of claim 13, wherein the controller controls the display to show information regarding the number of non-selected areas to which each progressive award level is allocated.

15. The gaming system of claim 10, wherein the controller indicates the stored result of the secondary game on the display while the controller executes the primary game.

16. The gaming system of claim 10, further comprising another display,
wherein the controller indicates the stored result of the secondary game on another display while the controller executes the primary game.

17. A method of executing a game program in a gaming machine having a display, comprising the steps of:
executing a primary game;
executing a secondary game in which a plurality of areas are defined on the display such that an award is allocated to at least one of the plurality of areas and when an area to which the award has been allocated is selected, a process according to the award is executed; and
storing a result of the secondary game inclusive of information regarding the selected area so that the stored result of the secondary game is used in a next secondary game.

18. The method of claim 17, wherein a visual indication for indicating the at least one of the plurality of areas to which the award is allocated is shown on the display, and the selection of an area is carried out by using a random number.

19. The method of claim 17, wherein the display is controlled to show a selector for visually indicating the result of selection of one of the plurality of areas.

20. The method of claim 19, wherein the selector includes an object shown on the display, and the method comprises the step of selecting one of the plurality of areas by using a random number and causing the object to move to the selected area in the secondary game.
